(19) United States
(12) Patent Application Publication
(10) Pub. No.: US 2008/0305929 A1
(43) Pub. Date: Dec. 11, 2008

(54) SHIFT CONTROL SYSTEM, SHIFT CONTROL METHOD, VEHICLE CONTROL SYSTEM AND VEHICLE CONTROL METHOD

(75) Inventor: Nobuhiko KOGA, Toyoake-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/133,039

(22) Filed: Jun. 4, 2008

(30) Foreign Application Priority Data
Jun. 5, 2007 (JP) 2007-149400

(51) Int. Cl. B60W 10/04

(52) U.S. Cl. 477/115

(57) ABSTRACT

A shift control system and a shift control method perform shift control of an automatic transmission in a vehicle that includes a catalyst and an air-fuel ratio detector. The shift control system includes an operation detector that detects an operation corresponding to a drivel's request for stopping of the vehicle, and a condition detecting/estimating unit that detects or estimates a condition of at least one of the catalyst and the air-fuel ratio detector. In the shift control system and shift control method, if the operation corresponding to the driver's request for stopping of the vehicle is detected when an operation to switch the automatic transmission from a non-driving range to a driving range is selected is performed, the automatic transmission is controlled so that driving force of the engine is not substantially transmitted to the driving wheels, based on the detected or estimated result of at least one of the catalyst and the air-fuel ratio detector.

### INCORPORATION BY REFERENCE

The disclosure of Japanese Patent Application No. 2007-149400 filed on Jun. 5, 2007, including the specification, drawings and abstract, is incorporated herein by reference in its entirety.

### BACKGROUND OF THE INVENTION

1. Field of the Invention

This invention relates to a shift control system and a control method thereof, and a vehicle control system and a control method thereof, and in particular to a shift control system that controls shifting of an automatic transmission and a control method thereof, and a vehicle control system and a control method thereof.

2. Description of the Related Art

When the driver shifts an automatic transmission (AT) to a gear position (gear ratio or speed ratio) corresponding to a driving range, in response to a driver's operation to switch from a non-driving range (N range, P range) to a driving range (D range), drag torque is produced in a torque converter, and the load of the engine (internal combustion engine) is increased. Therefore, the quantity (or flow rate) of intake air suddenly changes when the transmission shifts. In this case, if a catalyst for cleaning exhaust gas and an A/F sensor (air-fuel ratio detector) for detecting the air-fuel ratio of exhaust gas are not functioning optimally, exhaust emissions (i.e., the amount of pollutants discharged) may be increased. For example, if the A/F sensor has not been activated when the catalyst is sufficiently activated during cold starting of the engine, the exhaust emissions may be increased as explained below.

If the A/F sensor has not been activated, the air-fuel ratio cannot be correctly detected, and therefore, the feedback control of the air-fuel ratio cannot be appropriately executed in accordance with detection results of the A/F sensor. Thus, if the intake air quantity suddenly changes, the air-fuel ratio cannot be controlled in accordance with the sudden change in the intake air quantity, resulting in fluctuations in the air-fuel ratio and an increase in the exhaust emissions.

Also, after shifting of the automatic transmission the intake air quantity increases due to the increase in the load of the engine, resulting in an increase in the amount of exhaust gas discharged from the engine into an exhaust passage. If the amount of the exhaust gas is increased while the feedback control of the air-fuel ratio is not performed, the catalyst provided in the exhaust passage is not able to sufficiently clean the exhaust gas, and the exhaust emissions may be increased.

Japanese Patent Application Publication No. 2004-44722 (JP-A-2004-44722) describes a vehicular neutral control system that keeps the exhaust purification efficiency or catalytic conversion efficiency of a catalyst at a high level, while assuring improved fuel economy.

In the vehicular neutral control system described in JP-A-2004-44722, when certain vehicle conditions are satisfied while the automatic transmission is placed in a driving position, an electronic control unit executes a neutral control to forcibly bring the automatic transmission into a condition equivalent to a neutral condition, to improve fuel economy. The electronic control unit controls initiation and termination of the neutral control, depending on the temperature of a catalyst provided in the vehicle. In this manner, the catalyst temperature is controlled so that the exhaust purification efficiency or catalytic conversion efficiency can be maintained at a high level. It is thus possible to improve the fuel economy while keeping high exhaust purification efficiency.

When the automatic transmission switches from a non-driving range to the driving range while a catalyst that cleans exhaust gas or an air-fuel ratio detector that detects the air-fuel ratio of the exhaust gas, is not functioning optimally, for example, during cold starting of the engine, it is desirable to reduce or at least avoid increasing in exhaust emissions (i.e., an increase in the amount of pollutants emitted from the engine).

### SUMMARY OF THE INVENTION

The invention provides shift control system and a control method that reduces, or avoids increasing, exhaust emissions when the automatic transmission is switched from a non-driving range to a driving range while a catalyst that cleans exhaust gas or an air-fuel ratio detector that detects the air-fuel ratio of the exhaust gas is not functioning optimally, for example, during cold starting of the engine.

A first aspect of the invention provides a shift control system that executes a shift control of an automatic transmission provided in a power transmission path between an internal combustion engine and driving wheels, in a vehicle that includes a catalyst that cleans exhaust gas emitted from the internal combustion engine and an air-fuel ratio detector that detects an air-fuel ratio of the exhaust gas. The shift control system includes an operation detector that detects an operation corresponding to a driver's request for stopping of the vehicle, and a condition detecting/estimating unit that detects or estimates a condition of at least one of the catalyst and the air-fuel ratio detector. In the shift control system, if the operation corresponding to the driver's request for stopping of the vehicle is detected by the operation detector when an operation to switch the automatic transmission from a non-driving range to a driving range is performed, the automatic transmission is controlled so that driving force of the internal combustion engine is not substantially transmitted to the driving wheels, based on a result of detection or estimation by the condition detecting/estimating unit.

According to a second aspect of the invention provides a shift control method in all automatic transmission provided in a power transmission path between an internal combustion engine and driving wheels, in a vehicle that includes a catalyst that cleans exhaust gas emitted from an internal combustion engine and an air-fuel ratio detector that detects an air-fuel ratio of the exhaust gas. The shift control method includes: detecting an operation corresponding to a driver's request for stopping the vehicle, and detecting or estimating a condition of at least one of the catalyst and the air-fuel ratio detector. In this method, if the operation corresponding to the driver's request for stopping the vehicle is detected when an operation to switch the automatic transmission from a non-driving range to a driving range is selected is performed, the automatic transmission is controlled so that the driving force of the internal combustion engine is not substantially transmitted to the driving wheels, based on a result of detection or estimation of the condition of at least one of the catalyst and the air-fuel ratio detector.

According to the shift control system and shift control method of the invention as described above, the exhaust emissions are less likely to increase or are prevented from increasing when the operation to switch the automatic transmission from a non-driving range to a driving range is performed while the catalyst that cleans exhaust gas or the air-fuel ratio detector that detects the air-fuel ratio of the exhaust gas is not functioning optimally, for example, during cold starting of the engine.

The invention also provides a vehicle control system that includes the shift control system described above and further includes a braking device that applies a brake to the vehicle, and a braking control unit that controls the braking device. In the vehicle control system, when the automatic transmission is controlled so that the driving force of the internal combustion engine is not substantially transmitted to the driving wheels, the braking control unit controls the braking device to brake the vehicle. The invention further provides a control method of a vehicle control system in which the vehicle controlled by the shift control method as described above further includes a braking device that applies a brake to the vehicle, and a braking control unit that controls the braking device. In the control method, when the automatic transmission is controlled so that the driving force of the internal combustion engine is not substantially transmitted to the driving wheels, the braking control unit controls the braking device to brake the vehicle.

When the driving force of the internal combustion engine is not substantially transmitted to the driving wheels, creep torque is not produced in the automatic transmission, and therefore, the vehicle may travel backward if the vehicle is stopped on a up-grade road or uphill, for example. According to the vehicle control system and its control method as described above, the braking force acts on the vehicle, thereby preventing the vehicle from travelling backward.

### BRIEF DESCRIPTION OF THE DRAWINGS

The foregoing and further features and advantages of the invention will be better understood by reading the following detailed description of example embodiments of the invention, when considered in connection with the accompanying drawings, in which:

FIG. 1 is a schematic view showing the construction of a shift control system according to a first embodiment of the invention;

FIG. 2 is a flowchart illustrating the operation of the shift control system according to the first embodiment of the invention; and

FIG. 3 is a flowchart illustrating the operation of a shift control system according to a second embodiment of the invention.

### DETAILED DESCRIPTION OF THE PREFERRED EMBODIMENTS

In the following description and the accompanying drawings, the present invention will be described in greater detail with reference to the example embodiments.

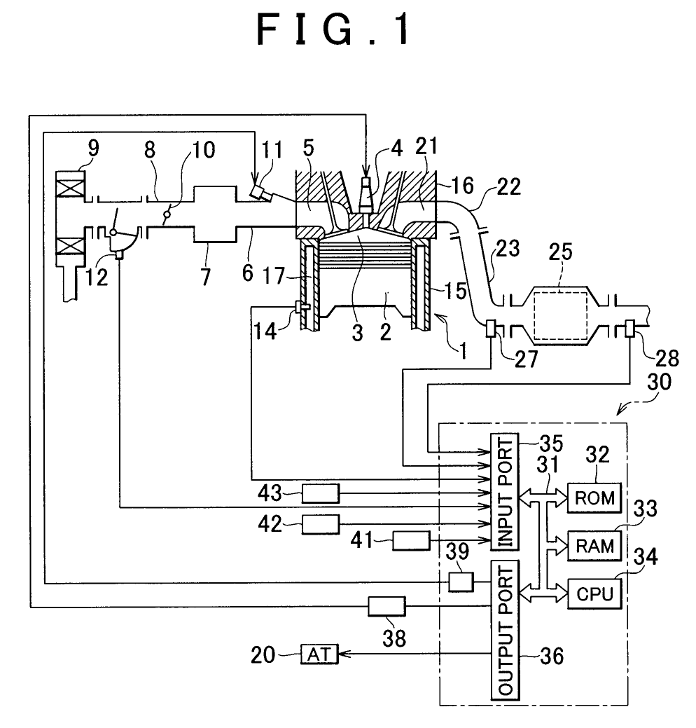

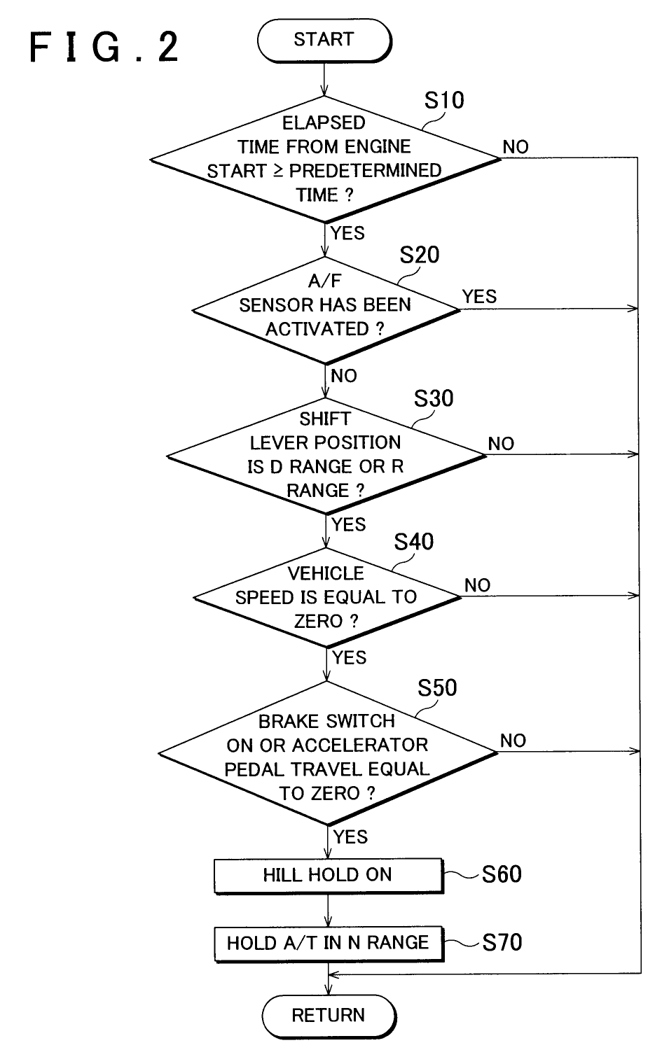

Referring to FIG. 1 and FIG. 2, a first embodiment of the invention will be explained. This embodiment relates to a shift control system for controlling shifting of an automatic transmission.

In this embodiment, even if the driver shifts the shift lever from the N range (non-driving range) to the D range (driving range) before an A/F sensor for detecting the air-fuel ratio of exhaust gas is activated and feedback control of the air-fuel ratio is started, for example, during cold start of an engine (internal combustion engine), the gear position (gear ratio or speed ratio) of the automatic transmission remains unchanged, namely, the automatic transmission is maintained in a neutral position corresponding to the N range while an operation (e.g., brake ON) corresponding to a driver's request for stopping of the vehicle is detected.

Even if the shift position is changed to the D range, i.e., the shift lever is shifted to the D range, a command for a vehicle stopping condition is issued by the driver while the brake pedal is depressed (brake ON). It is therefore possible to maintain the automatic transmission in the neutral gear position corresponding to the N range.

By maintaining the automatic transmission in the neutral gear position corresponding to the N range, it is possible to curb or avoid changes in the load resulting from shifting to a gear position corresponding to the D range. Consequently, exhaust emissions (i.e., the amount of pollutants discharged) are prevented from increasing due to fluctuations in the air-fuel ratio.

FIG. 1 schematically shows the construction of a system according to the present embodiment. In FIG. 1, an engine 1 has a cylinder block 15 in which a piston 2 is received such that the piston 2 can reciprocate within the cylinder block 15. A combustion chamber 3 is formed on the top side of the piston 2. A cylinder head 16 is disposed on the top of the cylinder block 15. Intake port 5 and exhaust port 21 are formed in the cylinder head 16. Also, an ignition plug 4 is mounted in the cylinder head 16. The ignition plug 4 ignites an air-fuel mixture that is compressed in the combustion chamber 3.

The intake port 5 is connected to a surge tank 7 via an intake manifold 6. The surge tank 7 is connected to an air cleaner 9 via an intake passage 8. An air flow meter 12 is mounted in the intake passage 8 and outputs a voltage signal proportional to the quantity or rate of flow of intake air. A throttle valve 10 is located downstream of the air flow meter 12 in the intake passage 8 as viewed in the direction of flow of the intake air. The throttle valve 10 adjusts the quantity of air supplied to the engine 1. A fuel injection valve 11 for injecting fuel into the intake port 5 is provided in the intake manifold 6.

A coolant channel 17 is formed in the cylinder block 15. A coolant temperature sensor 14 for detecting the temperature of a coolant flowing through the coolant channel 17 is mounted in the cylinder block 15. The coolant temperature sensor 14 outputs a voltage signal that indicates the temperature of the coolant.

The exhaust port 21 is connected to an exhaust passage 23 via an exhaust manifold 22. A catalyst 25 for cleaning exhaust gas is disposed in the exhaust passage 23. In operation, exhaust gas emitted from the engine 1 is cleaned or treated by the catalyst 25.

The catalyst 25 adsorbs a certain amount of oxygen. The catalyst 25 uses the adsorbed oxygen to oxidize unburned components, such as hydrocarbon (HC) and carbon monoxide (CO) contained in the exhaust gas. When nitrogen oxides (NOx) are contained in the exhaust gas, the catalyst 25 reduces the nitrogen oxides, and adsorbs oxygen released from reduction of the nitrogen oxides.

An A/F sensor (air-fuel ratio detector) 27 for detecting the oxygen concentration in the exhaust gas is disposed upstream of the catalyst 25 in the exhaust passage 23. The A/F sensor 27 detects the air-fuel ratio of an air-fuel mixture burned by the engine 1, based on the oxygen concentration of exhaust gas flowing into the catalyst 25.

An O₂ sensor 28 for detecting the oxygen concentration in the exhaust gas is disposed downstream of the catalyst 25 in the exhaust passage 23. The O₂ sensor 28 detects the oxygen concentration of exhaust gas flowing out of the catalyst 25.

A control circuit 30 is provided in the vehicle (not shown) on which the engine 1 is installed. The control circuit 30 incorporates a digital computer having a known configuration, which includes ROM (read-only memory) 32, RAM (random access memory) 33, CPU (microprocessor) 34, input port 35 and output port 36, which are connected to each other by a bi-directional bus 31. The control circuit 30 controls various operations of the engine 1 such as, for example, the fuel injection quantity, the ignition timing, etc.

The input port 35 of the control circuit 30 receives the detection results from the air flow meter 12, coolant temperature sensor 14, A/F sensor 27 and the O₂ sensor 28, via respective A/D converters (not shown). The vehicle is provided with a brake switch 41 and an acceleration stroke sensor 43. The brake switch 41 outputs an ON signal when the amount of depression of the brake pedal (not shown) is equal to or greater than a predetermined amount. The acceleration stroke sensor 43 detects the accelerator pedal travel, i.e., the amount of depression of the accelerator pedal (not shown).

The vehicle is also provided with a shift position sensor 42 for detecting the shift position of a shift lever (not shown) of the automatic transmission 20 (which will be described later). The input port 35 of the control circuit 30 receives the reduction results from the brake switch 41, shift position sensor 42, and the acceleration stroke sensor 43. In this embodiment, the operation detector of the invention includes the brake switch 41 and the acceleration stroke sensor 43.

The output port 36 of the control circuit 30 is connected to the ignition plug 4 via an ignition circuit 38. The control circuit 30 calculates the ignition timing from the load of the engine 1, the engine speed, etc. The control circuit 30 outputs an ignition signal to the ignition circuit 38, based on the calculated ignition timing.

The output port 36 of the control circuit 30 is also connected to the fuel injection valve 11 via a drive circuit 39. The control circuit 30 determines the fuel injection quantity, based on the intake air quantity, engine speed, etc. The control circuit 30 sets the duration for which the fuel injection valve 11 is held open to allow injection of the fuel, according to the determined fuel injection quantity.

The output port 36 of the control circuit 30 is also connected to the automatic transmission 20. The automatic transmission 20 connects the engine 1 with the driving wheels, via a torque converter included in the automatic transmission 20. The automatic transmission 20 changes the gear position (gear ratio or speed ratio) based on a signal (shift command) from the control circuit 30. For example, a hydraulic pressure supplied to the automatic transmission 20 is controlled in response to a signal from the control circuit 30, so that the automatic transmission 20 is upshifted or downshifted. The automatic transmission 20 may be a stepped automatic transmission, a continuously variable transmission, or an automatic transmission installed on a hybrid vehicle. In this embodiment, the control circuit 30 functions as the condition detecting/estimating unit and braking control unit of the invention.

FIG. 2 is a flowchart showing the operation of the system of the present embodiment. In step S10 of FIG. 2, the control circuit 30 determines whether the time that has elapsed since the engine 1 is started is equal to or exceeds a predetermined time. The predetermined time may be set as the length of time it takes until the rotational speed of the engine 1 is stabilized after the engine 1 is started. If it is determined in step S10 that the elapsed time from start of the engine 1 is equal to or exceeds the predetermined time (YES in step S10), the control proceeds to step S20. If the elapsed time is shorter than the predetermined time (NO in step S10), the current cycle of the control flow of FIG. 2 ends, and returns to the beginning of the operation.

In step S20, it is determined whether the A/F sensor 27 has been activated. It is determined that the A/F sensor 27 has been activated if the A/F sensor 27 is able to correctly detect the air-fuel ratio. Specifically, the control circuit 30 determines whether the A/F sensor 27 has been activated based on, for example, a signal received from the A/F sensor 27. If it is determined that the A/F sensor 27 has been activated, control (feedback control) of the air-fuel ratio based on the result of detection of the A/F sensor 27 is started. If it is determined in step S20 that the A/F sensor 27 has not been activated (NO in step S20), the control proceeds to step S30. If it is determined that the A/F sensor 27 has been activated (YES in step S20), the current cycle of the control flow of FIG. 2 is finished.

In step S30, it is determined whether the position of the shift lever is either the D range or the R range. Namely, it is determined in step S30 whether a driving range is selected for the automatic transmission 20. Specifically, the control circuit 30 determines whether a driving range is selected for the automatic transmission 20 based on information received from the shift position sensor 42. If it is determined that the shift lever position is the D range or the R range (YES in step S30), the control proceeds to step S40. If not (NO in step S30), the current cycle of the control flow of FIG. 2 ends.

In step S40, the control circuit 30 determines whether the vehicle speed is equal to zero. If it is determined that the vehicle speed is equal to zero (YES in step S40), the control proceeds to step S50. If not (NO in step S40), the current cycle of the control flow of FIG. 2 ends.

In step S50, it is determined whether the brake switch 41 is ON, and the accelerator pedal travel is equal to zero (i.e., the accelerator pedal is not depressed). Namely, it is determined in step S50 whether an operation corresponding to a driver's request for stopping of the vehicle is detected. Specifically, the control circuit 30 determines whether the brake switch 41 is ON, and the accelerator pedal travel is equal to zero based on information received from the brake switch 41 and the acceleration stroke sensor 43, respectively. If it is determined that the brake switch 41 is ON, and the accelerator pedal travel is equal to zero (YES in step S50), the control proceeds to step S60. If not (NO in step S50), the current cycle of the control flow of FIG. 2 ends.

In step S60, the control circuit 30 turns hill-hold ON. Namely, hill-hold control (braking control) for maintaining a stopped condition of the vehicle is executed in step S60. For example, the hill-hold control may be implemented by holding a hydraulic pressure of a brake system (braking device) at a certain level by means of a solenoid-operated valve(s), or the like. After step S60 is completed, the control proceeds to step S70.

In step S70, the automatic transmission 20 is maintained in a gear position corresponding to a non-driving range selected before the shift lever is operated to the D or R range (step S30), according to a command of the control circuit 30. In step S70, the automatic transmission 20 is brought into a condition where the driving force of the engine 1 is not substantially transmitted to the driving wheels of the vehicle. After execution of step S70, the current cycle of the control flow of FIG. 2 ends, and the control returns to the beginning of the operation.

According to this embodiment, before it is determined that the A/F sensor 27 has been activated (step S20), the automatic transmission 20 is held in the gear position corresponding to the non-driving range (namely, the gear position of the automatic transmission 20 remains unchanged) (step S70) even if the shift lever is moved to the driving range (YES in step S30).

When the vehicle is driven, even when the shift lever is operated from the N (non-driving) range to the D (driving) range, the vehicle may not be immediately started, but the brake pedal may be kept depressed (the brake system may be held in the ON state). In this case, the embodiment makes it possible or more likely to suppress or prevent deterioration of exhaust emissions when the shift lever is moved from the non-driving range to the driving range during cold startup of the engine.

When the automatic transmission 20 is shifted from the N (neutral) position (non-driving range) to the D (drive) position (driving range), drag torque is produced in the torque converter, resulting in an increase in the load of the engine 1 and a rapid change in the intake air quantity. In this case, if the A/F sensor 27 has not been activated, the air-fuel ratio cannot be adequately controlled in a feedback manner, resulting in fluctuations in the air-fuel ratio. In the embodiment, before the A/F sensor 27 is activated, the automatic transmission 20 is maintained in the gear position corresponding to the non-driving range even if the driving range is selected. As a result, the intake air quantity does not change rapidly, and the occurrence of fluctuations in the air-fuel ratio is prevented or curbed.

Also, while the automatic transmission 20 is held in the gear position corresponding to the non-driving range, the temperature of the catalyst 25 increases, and the catalytic conversion efficiency of the catalyst 25 increases. Accordingly, even where a brake OFF operation is performed (i.e., the brakes are released) and shifting of the automatic transmission 20 takes place before the A/F sensor 27 is activated, thereby increasing the load on the engine 1 and causing fluctuations in the air-fuel ratio, the catalyst 25 whose conversion efficiency has been improved is more likely to reduce or remove pollutants from the exhaust gas. Thus, the exhaust emissions are prevented from increasing or at least less likely to increase to when the control of this embodiment is not executed.

If the automatic transmission 20 is shifted in a gear position corresponding to a driving range, drag torque is produced in the torque converter, and the load on the engine 1 becomes a relatively large value, as compared with the case where the automatic transmission 20 is maintained in a gear position corresponding to a non-driving range. As a result, the amount of exhaust gas passing through the catalyst 25 is increased. If the amount of exhaust gas passing through the catalyst 25 increases while the feedback control of the air-fuel ratio cannot be performed before activation of the A/F sensor 27, the exhaust emissions may increase. In the present embodiment, even if the driving range is selected, the automatic transmission 20 is maintained in the gear position corresponding to the non-driving range (i.e., the gear position corresponding to the non-driving range is maintained) before the A/F sensor 27 is activated, and therefore, an increase in the amount of exhaust gas passing through the catalyst 25 is prevented.

While the automatic transmission 20 is held in the gear position corresponding to the non-driving range, the temperature of the catalyst 25 increases, and the catalytic conversion efficiency of the catalyst 25 increases. Accordingly, even if the brakes are released and shifting of the automatic transmission 20 is effected before the A/F sensor 27 is activated, thereby increasing the load on the engine 1 and increasing the amount of exhaust gas that passes through the catalyst 25, the catalyst 25 whose conversion efficiency has been improved is more likely to reduce or remove pollutants from the exhaust gas. Thus, the exhaust emissions are prevented from increasing or at least less likely to increase as compared to when the control of this embodiment is not executed.

If it is determined that the A/F sensor 27 has been activated (YES in step S20) while the automatic transmission 20 is held in the gear position corresponding to the non-driving range, the automatic transmission 20 is immediately shifted to a gear position corresponding to the selected driving range. Thus, deterioration in the driveability of the vehicle is avoided. If the control to maintain the gear position corresponding to the non-driving range continues to be executed, a certain length of time is required for shifting to the gear position corresponding to the selected driving range when the driver releases the brakes or depresses the accelerator to accelerate the vehicle, which results in a slight delay in the production or transmission of torque. In the embodiment, on the other hand, the automatic transmission 20 is shifted to the gear position corresponding to the selected driving range immediately after it is determined that the A/F sensor 27 is activated, and therefore, a torque delay as described above is less likely to occur or is prevented from occurring. Consequently, the driveability is improved when the vehicle is subsequently started.

While the control for holding the automatic transmission 20 in the gear position corresponding to the previously selected non-driving range is executed so that the driving force of the engine 1 is not substantially transmitted to the driving wheels of the vehicle in this embodiment, the content of the control is not limited to that of the illustrated embodiment. For example, the automatic transmission 20 may be prepared for shifting to the gear position corresponding to the selected driving range, without allowing the driving force of the engine 1 to be substantially transmitted to the driving wheels of the vehicle. More specifically, a hydraulic pressure of a clutch in the automatic transmission 20 may be controlled to a predetermined value. The predetermined value is set to a value that enables or permits the preparation for shifting of the automatic transmission 20 (e.g., application of the maximum non-engaging pressure to the hydraulic clutch). With this control, when the driver performs a brake OFF operation or an accelerator ON operation so as to accelerate (or start) the vehicle, shifting of the automatic transmission 20 is shifted in a short time, and the torque delay as described above is less likely to occur or is prevented from occurring.

A first modified example of the first embodiment will be explained. When the control of the first embodiment (FIG. 2) is executed, the content of the control may be changed based on the gradient of the road on which the vehicle is stopped. For example, in a conventional system, if a driving range (D range) is selected when the vehicle is stopped on an up-grade road or uphill, the automatic transmission is shifted to a gear position corresponding to the driving range, and creep torque is produced which enables the vehicle to be stopped with light braking force. If the control for holding the automatic transmission in the gear position corresponding to the non-driving range is executed, on the other hand, no creep torque is produced, and the vehicle may descend or travel backward. Thus, is is possible to override the control for holding the automatic transmission in the gear position corresponding to the non-driving range may be inhibited as needed, depending on the gradient of the road, for example.

Also, it may be determined whether the hill-hold control is to be executed, according to the gradient of the road. For example, the hill-hold control may be executed if the road on which the vehicle is stopped has a certain gradient.

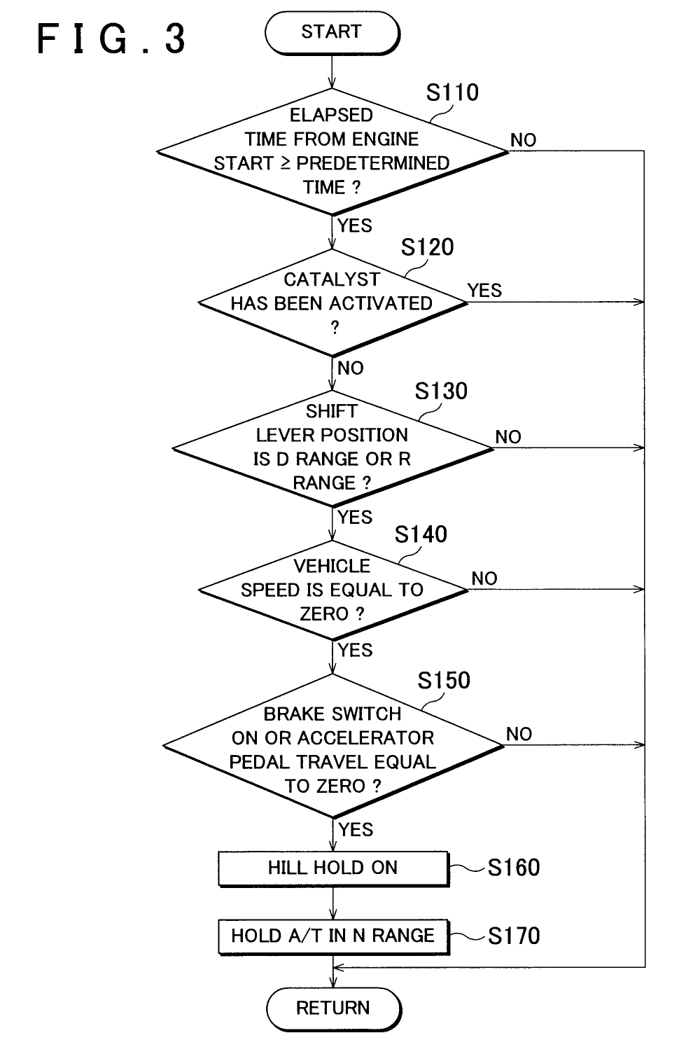

Referring next to FIG. 3, a second embodiment of the invention will be described only with respect to its feature different from the first embodiment. In the first embodiment (FIG. 2) as described above, the determination as to whether the control proceeds to step S70 of holding the automatic transmission 20 in the gear position corresponding to the non-driving range is made based on the determination as to whether the A/F sensor 27 has been activated (step S20). In the second embodiment, it is determined whether the control should proceed to the step of holding the automatic transmission 20 in the gear position corresponding to the non-driving range, based on a determination as to whether the catalyst 25, in place of the A/F sensor 27, has been activated.

For example, even if the A/F sensor 27 has not been activated, and feedback control of the air-fuel ratio cannot be performed, exhaust gas may be sufficiently cleaned by the catalyst 25 if it catalytic conversion efficiency is sufficient. Thus, it can be determined whether the control should proceed to the step of holding the automatic transmission in the gear position corresponding to the non-driving range, based on the determination as to whether the catalyst 25 has been activated.

FIG. 3 is a flowchart illustrating the operation of the system of the second embodiment. As in step S10 of the first embodiment (FIG. 2), if it is determined that a predetermined time has elapsed since the start of the engine 1 (YES in step S110), the control proceeds to step S120. If a negative decision (NO) is obtained in step S110, the current cycle of the control flow of FIG. 3 ends and the control returns to the beginning of the operation.

In step S120, it is determined whether the catalyst 25 has been activated. If the catalytic conversion efficiency of the catalyst 25 has reached a predetermined level, it is determined that the catalyst 25 has been activated. Specifically, the control circuit 30 determines whether the catalyst 25 has been activated in step S120, based on, for example, the total amount of intake air supplied to the engine 1 after the engine 1 is started. If it is determined that the catalyst 25 has not been activated (NO in step S120), the control proceeds to step S130. If it is determined that the catalyst 25 has been activated (YES in step S120), the current cycle of the control flow of FIG. 3 ends.

The operations from step S130 to step S170 are similar to the operations from step S30 to step S70 of the first embodiment. If the following conditions are satisfied: 1) if a driving range is selected (YES in step S130), 2) the vehicle speed is equal to zero (YES in step S140), 3) the brake switch 41 is ON and the accelerator pedal travel is equal to zero (YES in step S150), then the hill-hold control is performed (hill-hold ON) (step S160), and the automatic transmission 20 is held in a gear position corresponding to the non-driving range (step S170).

A first modified embodiment of the second embodiment will now be described. In the second embodiment as described above, the determination as to whether the control should proceed to the step of holding the automatic transmission in the gear position corresponding to the non-driving range is made based on the determination as to whether the A/F sensor 27 has been activated (step S120). In the modified example, it is determined whether the control should proceed to the step of holding the automatic transmission in the gear position corresponding to the non-driving range, based on determinations as to whether the A/F sensor 27 has been activated and whether the catalyst 25 has been activated.

In this case, if it is determined that at least one of the A/F sensor 27 or the catalyst 25 has not been activated, the automatic transmission 20 is held in the gear position corresponding to the non-driving range. Namely, it is determined in step S120 whether at least one of a condition that the A/F sensor 27 has not been activated and a condition that the catalyst 25 has not been activated is satisfied.

If it is determined that at least one of the A/F sensor 27 or the catalyst 25 is not activated (NO in step S120), the control proceeds to step S130. If both of the A/F sensor 27 and the catalyst 25 are activated (YES in step S120), on the other hand, the current cycle of the process of FIG. 3 ends. Thus, if both the A/F sensor 27 and the catalyst 25 are activated (YES in step S120), the control for holding the automatic transmission 20 in the gear position corresponding to the non-driving range is terminated. In other words, the control for holding the automatic transmission 20 in the gear position corresponding to the non-driving range is executed until the feedback control of the air-fuel ratio is executed and the catalyst 25 has a sufficiently high catalytic conversion efficiency. Consequently, the likelihood that exhaust emissions are increased is more reliably reduced.

A second modified example of the second embodiment will now be described. In the first modified example of the second embodiment as described above, if it is determined that at least one of either the A/F sensor 27 or the catalyst 25 has not been activated, the automatic transmission 20 is held in the gear position corresponding to the non-driving range. In the second modified example, if it is determined that neither the A/F sensor 27 nor the catalyst 25 has been activated, the automatic transmission 20 is held in the gear position corresponding to the non-driving range.

In step S120, it is determined whether the A/F sensor 27 has not been activated and whether the catalyst 25 has not been activated are both satisfied. If both of the condition that the A/F sensor 27 has not been activated and the condition that the catalyst 25 has not been activated are satisfied (NO in step S120), the control proceeds to step S130. If either of these conditions is not satisfied, namely, if one or both of the A/F sensor 27 and the catalyst 25 has/have been activated (YES in step S120), the current cycle of the control flow of FIG. 3 ends. Thus, if at least one of the A/F sensor 27 has been activated or the catalyst 25 has been activated, the control for maintaining the automatic transmission 20 in the gear position corresponding to the non-driving range is terminated.

If at least one of the A/F sensor 27 and the catalyst 25 has been activated, the exhaust emissions are less likely or unlikely to increase, as compared with the case where both of the A/F sensor 27 and the catalyst 25 have not been activated. For example, if the A/F sensor 27 is activated, the feedback control of the air-fuel ratio may be appropriately performed, so that the exhaust emissions are less likely to increase or prevented from increasing. If the catalyst 25 is activated, on the other hand, the catalytic conversion efficiency of the catalyst 25 is considered to be adequate, and therefore the exhaust emissions are less likely to increase or prevented from increasing.

In certain situations, it may be desirable to terminate, at an early opportunity, a condition where shifting of the automatic transmission 20 is not carried out even though a command for shifting to a driving range is issued by the driver. In the second modified example, the automatic transmission 20 is shifted to the gear position corresponding to the selected driving range when it is determined that at least one of the AVF sensor 27 and the catalyst 25 is activated, so that the condition in which the actual gear position of the automatic transmission 20 does not match the currently selected shift lever position can be terminated early.

Also, if the control circuit 30 ceases to detect a driver's request for stopping of the vehicle (e.g., a signal indicative of release of the brake pedal or depression of the accelerator pedal) while the control for holding the automatic transmission 20 in the gear position corresponding to the non-driving range is executed, there is a slight delay in the production or transmission of torque as the transmission is shifted to the gear position corresponding to the selected driving range. According to the second modified example, on the other hand, the automatic transmission 20 is shifted to the gear position corresponding to the selected driving range when it is determined that at least one of the A/F sensor 27 and the catalyst 25 has been activated, so that the torque delay is minimized or prevented.

While the invention has been described with reference to example embodiments thereof, the invention is not limited to the described embodiments or constructions. To the contrary, the invention is intended to cover various modifications and equivalent arrangements. In addition, while the various elements of the example embodiments are shown in various example combinations and configurations, other combinations and configurations, including more, less or only a signal element, are also within the spirit and scope of the invention.

What is claimed is:

1. A shift control system that executes a shift control of an automatic transmission provided in a power transmission path between an internal combustion engine and driving wheels, in a vehicle that includes a catalyst that cleans exhaust gas emitted from an internal combustion engine and an air-fuel ratio detector that detects an air-fuel ratio of the exhaust gas, the shift control system comprising:
an operation detector that detects an operation corresponding to a driver's request for stopping of the vehicle; and
a condition detecting/estimating unit that detects or estimates a condition of at least one of the catalyst and the air-fuel ratio detector,
wherein if the operation corresponding to the driver's request for stopping of the vehicle is detected by the operation detector when an operation to switch the automatic transmission from a non-driving range to a driving range is performed, then the automatic transmission is controlled so that the driving force of the internal combustion engine is not substantially transmitted to the driving wheels, based on a result of detection or estimation by the condition detecting/estimating unit.

2. The shift control system according to claim 1, wherein the automatic transmission is controlled to be held in a gear position or at a gear ratio corresponding to the non-driving range, so that the driving force of the internal combustion engine is not substantially transmitted to the driving wheels.

3. The shift control system according to claim 1, wherein the condition detecting/estimating unit detects or estimates an activation status of at least one of the air-fuel ratio detector and the catalyst.

4. The shift control system according to claim 3, wherein the condition detecting/estimating unit detects or estimates the activation status of the catalyst, based on a catalytic conversion efficiency of the catalyst.

5. The shift control system according to claim 4, wherein the condition detecting/estimating unit detects or estimates the catalytic conversion efficiency of the catalyst based on a total amount of intake air supplied to the internal combustion engine.

6. The shift control system according to claim 3, wherein the condition detecting/estimating unit detects or estimates that the air-fuel ratio detector is activated when the air-fuel ratio detector produces a correct output.

7. A vehicle control system comprising:
the shift control system according to claim 1;
a braking device that applies a brake to the vehicle; and
a braking control unit that controls the braking device,
wherein when the automatic transmission is controlled so that the driving force of the internal combustion engine is not substantially transmitted to the driving wheels, the braking control unit controls the braking device to brake the vehicle.

8. A shift control method of performing shift control of an automatic transmission provided in a power transmission path between an internal combustion engine and driving wheels, in a vehicle that includes a catalyst that cleans exhaust gas emitted from an internal combustion engine and an air-fuel ratio detector that detects an air-fuel ratio of the exhaust gas, the shift control method comprising:
detecting an operation corresponding to a driver's request for stopping of the vehicle; and
detecting or estimating a condition of at least one of the catalyst and the air-fuel ratio detector;
wherein if the operation corresponding to the driver's request for stopping of the vehicle is detected when an operation to switch the automatic transmission from a non-driving range to a driving range is performed, then the automatic transmission is controlled so that the driving force of the internal combustion engine is not substantially transmitted to the driving wheels, based on a result of detection or estimation of the condition of at least one of the catalyst and the air-fuel ratio detector.

9. The shift control method according to claim 8, wherein
the automatic transmission is controlled to be held in a gear position or at a gear ratio corresponding to the non-driving range, so that the driving force of the internal combustion engine is not substantially transmitted to the driving wheels.

10. The shift control method according to claim 8, wherein an activation status of at least one of the air-fuel ratio detector and the catalyst is detected or estimated.

11. The shift control method according to claim 10, wherein the activation status of the catalyst is detected or estimated based on a catalytic conversion efficiency of the catalyst.

12. The shift control method according to claim 11, wherein the catalytic conversion efficiency of the catalyst is detected or estimated, based on a total amount of intake air supplied to the internal combustion engine.

13. The shift control method according to claim 10, wherein it is detected or estimated that the air-fuel ratio detector is activated when the air-fuel ratio detector produces a correct output.

14. A vehicle control method comprising:
the shift control method according to claim 8;
a braking device that applies a brake to the vehicle; and
a braking control unit that controls the braking device,
wherein when the automatic transmission is controlled so that the driving force of the internal combustion engine is not substantially transmitted to the driving wheels, the braking control unit controls the braking device to brake the vehicle.
